(19) United States
(12) Patent Application Publication
(10) Pub. No.: US 2004/0078177 A1
(43) Pub. Date: Apr. 22, 2004

(54) Test circuit for verifying a manufacturing process

(76) Inventor: Magnus Liljeblad, Stockholm (SE)

Correspondence Address: Stanley R Moore, Jenkens & Gilchrist, Suite 3200, 1445 Ross Avenue, Dallas, TX, 75202-2799, US

(21) Appl. No.: 10/468,627

(22) PCT Filed: Feb. 21, 2002
(86) PCT No.: PCT/SE02/00311

(30) Foreign Application Priority Data
Feb. 23, 2001 (TW) 90 1 04202

(51) Int. Cl. G06F 17/50

(52) U.S. Cl. 703/14

(57) ABSTRACT

A test circuit for measuring the delay of a signal through a manufactured integrated circuit in order to find discrepancies between simulation models corresponding to the used manufacturing process and the process itself, comprises a delay circuit (DLY). The simulation models of the delay circuit (DLY) are used to predetermine maximum and minimum allowable delays of a pulse edge supplied to the input terminal of the delay circuit. A first verifying circuit (4, 5, 6) connected to the output terminal of the delay circuit (DLY) verifies whether or not the delay of the pulse edge is above this predetermined minimum value. A second verifying circuit (7, 8, 9, DLYC, DLYS) connected to the output terminal of the delay circuit (DLY) verifies whether or not the delay of the pulse edge is below this predetermined maximum value.

### TECHNICAL FIELD

The invention relates generally to integrated circuits and more specifically to a test circuit for verifying a manufacturing process for such circuits.

### BACKGROUND OF THE INVENTION

When integrated circuits are manufactured, it is necessary to test whether or not the manufacturing process corresponds to simulation models of the process.

One parameter to be tested is the delay through signal paths of a manufactured circuit. The delay of such a circuit is dependent upon the manufacturing process itself, actual operating temperature, supply voltages etc. To check the circuit before starting the manufacturing process, a simulation model of the circuit is designed. This model is built-up from simulation models of all used lowest-level building blocks. The lowest-level building blocks are called leaf-cells.

Each leaf-cell has at least one simulation model and one layout model, of which the simulation model is used for simulations and the layout model is used when the manufacturing foundation is created. These models are directly or indirectly supplied by a company that has developed the manufacturing process and that finally manufactures the integrated circuit, and can be seen as the specification by the company of its process.

The simulation models are designed such that they contain a minimum allowable delay and a maximum allowable delay at a given voltage, a given temperature, and given variations in the manufacturing process.

Manufactured circuits are normally tested using an automatic test equipment. The accuracy of such a test equipment is limited. One normal test of a manufactured circuit is to measure the delay through a specific signal path of the circuit and check whether or not the measured delay lies between a minimum and a maximum allowable delay calculated on the basis of the simulation model of the signal path.

Such a test is normally carried out by applying a pulse edge to an input terminal and measuring the time until a related pulse edge appears on an output terminal. It can be very difficult to find a suitable signal path on which such a test can be carried out unless a very short signal path is chosen. A short signal path is difficult to measure accurately using automatic test equipment and is not affected by process variations in other areas of the manufactured circuit, although process variations tend to appear in bigger areas embracing several leaf-cells and not just in single leaf-cells.

### SUMMARY OF THE INVENTION

The object of the invention is to bring about a test circuit that makes it possible to carry out a delay test on a representative part of the whole manufactured chip.

This is attained in accordance with the invention by a test circuit that is manufactured on the same chip separate from a so-called mission-mode circuit. The mission-mode circuit implements the wanted functionality of the chip, while the test circuit is only used for test and verification, and is left inactive and unused during normal operation.

The test circuit according to the invention is built-up of the same type of leaf-cells as the mission-mode circuit. By letting the test circuit according to the invention be distributed over the chip area, it will be affected by process variations in a larger area of the chip. Also, by connecting the test circuit according to the invention between two opposite edges of the chip, it will represent a larger part of the chip.

The test circuit according to the invention comprises a delay circuit. Simulation models of the delay circuit are used to predetermine maximum and minimum allowable delays of a pulse edge supplied to the input terminal of the delay circuit. A first verifying circuit connected to the output terminal of the delay circuit verifies whether or not the delay of the pulse edge in the manufactured circuit is above this predetermined minimum value. A second verifying circuit connected to the output terminal of the delay circuit verifies whether or not the delay of the pulse edge is below this predetermined maximum value.

### BRIEF DESCRIPTION OF THE DRAWING

The invention will be described more in detail below with reference to the appended drawing on which

FIG. 1 shows a circuit diagram of an embodiment of a test circuit according to the invention, and

FIGS. 2a-h are diagrams illustrating different waveforms in the test circuit in FIG. 1.

### DESCRIPTION OF THE INVENTION

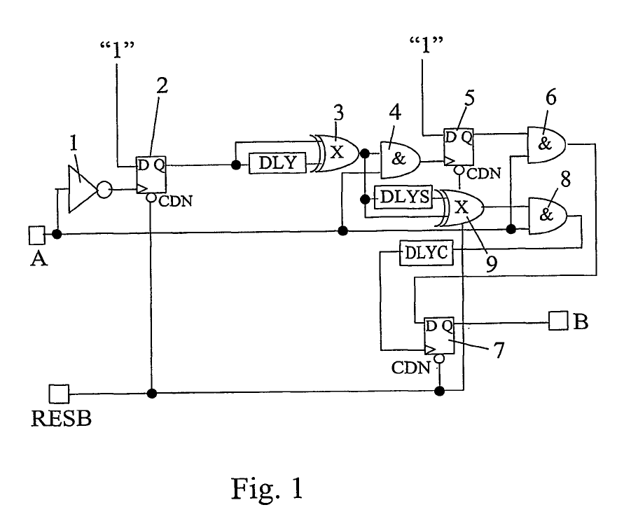

FIG. 1 shows a circuit diagram of an embodiment of a test circuit according to the invention. The test circuit has been manufactured on a chip (not shown) together with a mission-mode circuit (not shown) in one and the same process.

The circuit diagram in FIG. 1 also represents a simulation model of the test circuit according to the invention, built up of simulation models of a number of different leaf-cells.

The test circuit comprises a test signal input terminal A and a test signal output terminal B. In the embodiment in FIG. 1, the terminals A and B are supposed to be located along opposite edges of the chip (not shown).

The test signal input terminal A is connected to an input terminal of an inverter 1 whose output terminal is connected to a clock input terminal of a flip-flop 2. A data input terminal D of the flip-flop 2 is tied high as represented by a logic “1” in FIG. 1. An inverting reset terminal CDN of the flip-flop 2 is connected to a reset signal input terminal RESB.

A delay circuit DLY is connected with its input terminal to an output terminal Q of the flip-flop 2. The delay circuit DLY comprises a series circuit of either a plurality of leaf-cells of just one type, e.g. 300 NAND gates, or a plurality of leaf-cells of different types, e.g. inverters, gates, flip-flops etc. The delay circuit DLY should comprise as many leaf-cells as possible in order to be exposed to process variations over a larger area of the chip.

The output terminal of the delay circuit DLY is connected to one input terminal of an EXCLUSIVE-OR gate 3 whose other input terminal is connected to the input terminal of the delay circuit DLY, and whose output terminal is connected to one input terminal of an AND gate 4. The AND gate 4 is connected with its other input terminal to the test signal input terminal A, and with its output terminal to a clock input terminal of a flip-flop 5 whose data input terminal D is tied high as represented by a logic “1” in FIG. 1.

The flip-flop 5 is connected with its output terminal Q to one input terminal of an AND gate 6 whose other input terminal is connected to the test signal input terminal A. The inverting reset terminal CDN of the flip-flop 5 is connected to the reset signal input terminal RESB. The AND gate 6 is connected with its output terminal to the data input terminal D of a flip-flop 7 whose clock input terminal is connected to an output terminal of an AND gate 8 via a delay circuit DLYC comprising e.g. a delay element or a number of NAND gates. The AND gate 8 is connected with one input terminal to the test signal input terminal A, and with its other input terminal to an output terminal of an EXCLUSIVE-OR gate 9. The EXCLUSIVE-OR gate 9 is connected with one input terminal to the output terminal of the EXCLUSIVE-OR gate 3, and with its other input terminal to the same output terminal of the EXCLUSIVE-OR gate 3 via a delay circuit DLYS also comprising e.g. a delay element or a number of NAND gates.

The flip-flop 7 is connected with its inverting reset terminal to the reset signal input terminal RESB, and with its output terminal Q to the test signal output terminal B.

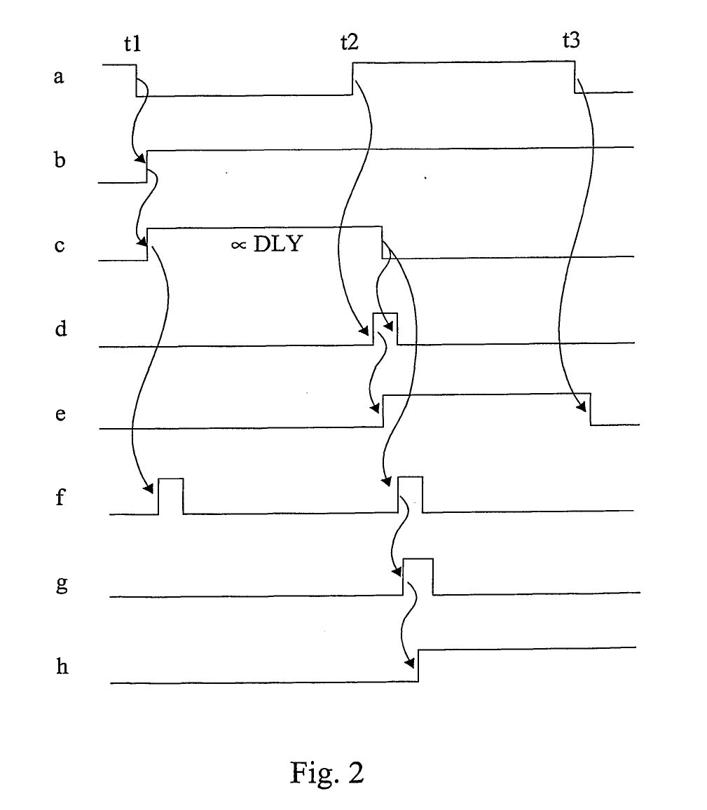

With reference to FIGS. 2a-h, it will now be described how a test signal to be applied to the input terminal A is determined by means of the simulation models of the test circuit.

In FIGS. 2a-h, arrows point to one pulse edge from another pulse edge causing it.

Using first simulation models representing parameters yielding minimum delay in the test circuit, the test signal input terminal A is set HIGH and the reset signal input terminal RESB is set LOW until a stable condition is obtained. Then, RESB is set HIGH.

At time t1, terminal A is set LOW as shown in FIG. 2a. This causes a HIGH to appear on the output terminal Q of the flip-flop 2 as shown in FIG. 2b, and a pulse to be generated on the output terminal of the EXCLUSIVE-OR gate 3 as shown in FIG. 2c. The length of the pulse corresponds to the delay of the delay circuit DLY.

A time t2 is chosen when terminal A is set HIGH again. This causes the output of the AND gate 4 to go HIGH as shown in FIG. 2d if the output of the EXCLUSIVE-OR gate 3 still is high, which it will be if time t2 is chosen early enough. Then, a rising edge on the output terminal of the AND gate 6 appears as shown in FIG. 2e. Time t2 is chosen as the latest possible time still achieving a rising edge on the output terminal of the AND gate 6 as shown in FIG. 2e, without any set-up or hold violation in any simulation model.

Using second simulation models representing parameters yielding maximum delay in the test circuit, the test signal input terminal A is set HIGH and the reset signal input terminal RESB is set LOW until a stable condition is obtained. Then, RESB is set HIGH.

As above, at time t1, terminal A is set LOW as shown in FIG. 2a. This causes a HIGH to appear on the output terminal Q of the flip-flop 2 as shown in FIG. 2b, and a pulse to be generated on the output terminal of the EXCLUSIVE-OR gate 3 as shown in FIG. 2c. At the chosen time t2, terminal A is set HIGH again. This causes the output of the AND gate 4 to go HIGH as shown in FIG. 2d. Then, a rising edge on the output terminal of the AND gate 6 appears as shown in FIG. 2e.

The falling edge of the pulse from the delay circuit DLY as shown in FIG. 2c causes a pulse to be generated on the output terminal of the EXCLUSIVE-OR gate 9 as shown in FIG. 2f. The length of the pulse in FIG. 2f corresponds to the delay of the delay circuit DLYS. If the test signal input terminal A is still HIGH, the rising edge of the pulse shown in FIG. 2f causes the output terminal of the AND gate 8 to go HIGH as shown in FIG. 2g. The rising edge of the pulse shown in FIG. 2g is applied to the clock input terminal of the flip-flop 7. The output terminal Q of the flip-flop 7 goes HIGH and consequently the test signal output terminal B goes HIGH.

Time t3 as shown in FIG. 2a is chosen as the earliest possible time still achieving a rising edge on the test signal output terminal B as shown in FIG. 2h, without any set-up or hold violation in any simulation model.

The delay circuit DLYC is not necessary but is often needed since both the data input signal and the clock input signal to the flip-flop 7 are generated from the falling edge on test signal input terminal A.

The test of the manufactured test circuit in FIG. 1 will be described below also with reference to FIGS. 2a-h.

The test signal input terminal A is set HIGH and the reset signal input terminal RESB is set LOW until a stable condition is obtained. Then, RESB is set HIGH.

At time t1, terminal A is set LOW as shown in FIG. 2a. At time t2, terminal A is set HIGH, and at time t3, terminal A is set LOW again as shown in FIG. 2a.

If the test signal output terminal B does not go HIGH as shown in FIG. 2h but remains LOW even after a short time after time t3, the simulation models do not correspond to the manufacturing process. In that case, the circuit has not been manufactured according to specifications. Thus, the simulation models and/or the manufacturing process must be modified by those who developed them.

An advantage of the test circuit according to the invention is that the output terminal B will stay HIGH or LOW after a short time after time t3. This makes it easier to carry out this test using automatic test equipment.

1. A test circuit for verifying a manufacturing process according to which an integrated circuit has been manufactured on a chip, characterized in
that the test circuit comprises a series-circuit (DLY) of circuit elements of at least one circuit element type, and first and second verification circuits (4, 5, 6; 7, 8, 9, DLYC, DLYS), the series-circuit as well as the first and second verification circuits having been manufactured on the chip in the same process as a mission-mode circuit,
that the series-circuit (DLY) is connected with its input to a test signal input (A) and with its output to an input of the first verification circuit (4, 5, 6) and to one input of the second verification circuit (7, 8, 9, DLYC, DLYS) whose other input is connected to an output of the first verification circuit and whose output is connected to a test signal output (B),
that the first verification circuit (4, 5, 6) is adapted to generate an output signal to the second verification circuit (7, 8, 9, DLYC, DLYS) when a test signal applied to the test signal input (A) is delayed at least a minimum time calculated on the basis of first simulation models representing parameters yielding minimum delay in the test circuit, and
that the second verification circuit (7, 8, 9, DLYC, DLYS) is adapted to generate an output signal to the test signal output (B) when the test signal at the most is delayed a maximum time calculated on the basis of second simulation models representing parameters yielding maximum delay in the test circuit, and the output signal from the first verification circuit (4, 5, 6) is present.

2. The arrangement according to claim 1, characterized in that the test signal input (A) and the test signal output (B) are located along opposite edges of the chip.
